(19) United States
(12) Patent Application Publication
(10) Pub. No.: US 2009/0086839 A1
(43) Pub. Date: Apr. 2, 2009

(54) METHODS AND DEVICES FOR DECODING AND ENCODING DATA

(75) Inventors: Changlong Xu, Singapore (SG); Ying Chang Liang, Singapore (SG); Wing Seng Leon, Singapore (SG)

Correspondence Address: CHOATE, HALL & STEWART LLP, TWO INTERNATIONAL PLACE, BOSTON, MA, 02110, US

(73) Assignee: Agency for Science, Technology and Research, Singapore (SG)

(21) Appl. No.: 12/092,936

(22) PCT Filed: Nov. 7, 2006
(86) PCT No.: PCT/SG2006/000337

§ 371 Date: Nov. 21, 2008

Related U.S. Application Data
(60) Provisional application No. 60/734,054, filed on Nov. 7, 2005.
(60) Provisional application No. 60/734,080, filed on Nov. 7, 2005.

(51) Int. Cl. H04L 29/00

(52) U.S. Cl. 375/262

(57) ABSTRACT

A method for decoding an input data sequence is provided. The method comprises generating a plurality of test sequences, determining an order for the plurality of test sequences, such that each test sequence differs from its adjacent test sequences by a respective predefined number of bits, and carrying out a maximum likelihood process with the ordered test sequences and the input data sequence thereby generating a maximum likelihood sequence.

The present application claims the benefit of U.S. provisional application Nos. 60/734,054 (filed on 7 Nov., 2005) and 60/734,080 (filed on 7 Nov., 2005), the entire contents of which are incorporated herein by reference for all purposes.

The present invention refers to methods of decoding and encoding data, as well as to respective devices.

Forward error correction (FEC) coding is used in communication technology, to enable a limited number of errors which had occurred during data transmission to be corrected at the receiving end. Recently, Berrou presented a new FEC coding scheme called turbo codes (TC) [1], which is able to achieve performance levels close to the theoretical limit on an additive white Gaussian noise (AWGN) channel predicted by Shannon's Theorem, using a soft-input soft-output (SISO) iterative decoder. This new coding scheme consists of two recursive systematic convolution codes concatenated in parallel, and as such, is commonly known as convolutional turbo codes (CTC).

Subsequently, Pyndiah presented the turbo product codes (TPC) [2][3], as well as an efficient decoding algorithm for the turbo product codes. The turbo product codes show a performance comparable to the convolutional turbo codes, and are able to support higher coding rates. Due to these advantages, turbo product codes have been used in the physical layer of the IEEE 802.16 network, as well as in satellite communications and digital storage systems.

These two recent developments demonstrate the tremendous amount of research work in the ongoing effort to obtain coding schemes with higher performance levels. Additional research effort is also spent on reducing the decoding complexity of these new coding schemes. For example, in order to further reduce the complexity of decoding turbo product codes, the Chase algorithm [4] is used to obtain extrinsic information on each bit position for iterative decoding.

The methods and devices, as defined in the respective independent claims of the present application, make further contributions towards this effort to obtain coding schemes with higher performance levels.

In a first aspect of the invention, a method of decoding an input data sequence is provided, comprising generating a plurality of test sequences, determining an order for the plurality of test sequences, such that each test sequence differs from its adjacent test sequences by a respective predefined number of bits, and carrying out a maximum likelihood process with the ordered test sequences and the input data sequence thereby generating a maximum likelihood sequence.

In a second aspect of the invention, a decoding device is provided, comprising a generator generating a plurality of test sequences, a first unit for determining an order for the plurality of test sequences, such that each test sequence differs from its adjacent test sequences by a respective predefined number of bits, and a second unit for carrying out a maximum likelihood process with the ordered test sequences and the input data sequence thereby generating a maximum likelihood sequence.

In a third aspect of the invention, a computer program product which, when executed by a computer, makes the computer perform a method for decoding an input data sequence is provided, comprising generating a plurality of test sequences, determining an order for the plurality of test sequences, such that each test sequence differs from its adjacent test sequences by a respective predefined number of bits, and carrying out a maximum likelihood process with the ordered test sequences and the input data sequence thereby generating a maximum likelihood sequence.

One embodiment described below can be seen as a modification of the Chase algorithm. A reduction of the complexity with respect to the original Chase algorithm in the decoding process can be achieved. The modifications may include arranging the test sequences such that each test sequence differs from its adjacent test sequences by a predetermined number of bits, and obtaining a new equation for computing the reliability indicator for maximum likelihood sequence, comprising a coefficient including the difference between the maximum weight and the weight of the maximum likelihood sequence. The complexity of the decoding process with the modified Chase algorithm is significantly reduced.

Embodiments of the invention emerge from the dependent claims.

In one embodiment, a reliability indicator for the maximum likelihood sequence generated may be determined. In another embodiment, the coefficient for the reliability indicator for maximum likelihood sequence obtained comprises the difference between the maximum weight and the weight of the maximum likelihood sequence. In still another embodiment, the coefficient for the reliability indicator for maximum likelihood sequence obtained further comprises the number of least reliable bit positions in the maximum likelihood sequence generated.

As used herein, the reliability indicator for maximum likelihood sequence generated refers to a value computed to measure the relative reliability of the maximum likelihood sequence obtained. The reliability indicator for maximum likelihood sequence generated, for example, may be but is not limited to, the extrinsic information of the maximum likelihood sequence.

In one embodiment, when an error is encountered, the test sequences may be perturbed. In another embodiment, the test sequences may be perturbed by inverting predetermined bits of the test sequences.

In one embodiment, the respective predefined number of bits is 1. This means that two adjacent test sequences differ only in 1 bit.

In a fourth aspect of the invention, a method of encoding an input data sequence is provided, comprising determining at least one encoding matrix, ordering the at least one encoding matrix determined, arranging the input data sequence into an input data matrix, and performing operations on the input data matrix using the at least one encoding matrix arranged thereby generating an encoded data block.

In a fifth aspect of the invention, an encoding device is provided, comprising a first unit for determining at least one encoding matrix, a second unit for ordering the at least one encoding matrix determined, a third unit for arranging the input data sequence into an input data matrix, and a fourth unit for performing operations on the input data matrix using the at least one encoding matrix arranged thereby generating an encoded data block.

In a sixth aspect of the invention, a computer program product which, when executed by a computer, makes the computer perform a method for encoding an input data sequence is provided, comprising determining at least one encoding matrix, ordering the at least one encoding matrix determined, arranging the input data sequence into an input data matrix, and performing operations on the input data matrix using the at least one encoding matrix arranged thereby generating an encoded data block.

Illustratively, a new encoding matrix is obtained by rearranging the encoding matrix such that the value of each column of the original encoding matrix is in ascending order. For an encoded data vector generated with this new encoding matrix, when an error occurs, at the decoder side, this error may be corrected directly using the error syndrome generated, simply by inverting the bit value in the position indicated by the error syndrome. However, for an encoded data vector generated with the original encoding matrix, further processing on the error syndrome generated is still needed in order to be able determine the position of the error bit. Accordingly, the decoding of an encoded data vector generated with this new encoding matrix is simplified.

In one embodiment, the at least one encoding matrix determined may be ordered by arranging the columns of the at least one encoding matrix such that the integer values represented by the bit values in each column are in an ascending order, wherein the bit at the top row corresponds to the least significant bit of each column.

In one embodiment, a column of predetermined values may be appended after the rightmost column of the at least one encoding matrix determined, and a row of predetermined values may be appended below the bottom row of the at least encoding matrix determined, before the at least one encoding matrix determined is ordered. In another embodiment, the column of predetermined values may be a column of all zeroes, and the row of predetermined values may be a row of all ones.

In one embodiment, predetermined rows of the encoded data block or predetermined columns of the encoded data block may be removed. In another embodiment, a predetermined set of continuous bits of the encoded data block may be removed or replaced with predetermined data. In yet another embodiment, the predetermined data may be a set of all zero values. In still another embodiment, the predetermined data may be cyclic redundancy check (CRC) data.

It can be seen from the method of decoding an input data sequence provided by the invention give the following advantage, namely, a decoding process using the method of decoding an input data sequence provided by the invention has lower complexity compared to a decoding process using the original Chase algorithm.

In addition, it can also be seen from the method of encoding an input data sequence provided by the invention, give the following advantage. For the encoded data vector or block generated using the method of encoding an input data sequence provided by the invention, when an error occurs, the bit position of the error may be directly obtained from the syndrome computed.

Accordingly, the decoding of an encoded data vector or block generated using the method of encoding an input data sequence provided by the invention, is simplified.

The embodiments which are described in the context of the method of decoding an input data sequence and the method of encoding an input data sequence provided, are analogously valid for the devices and the computer program products.

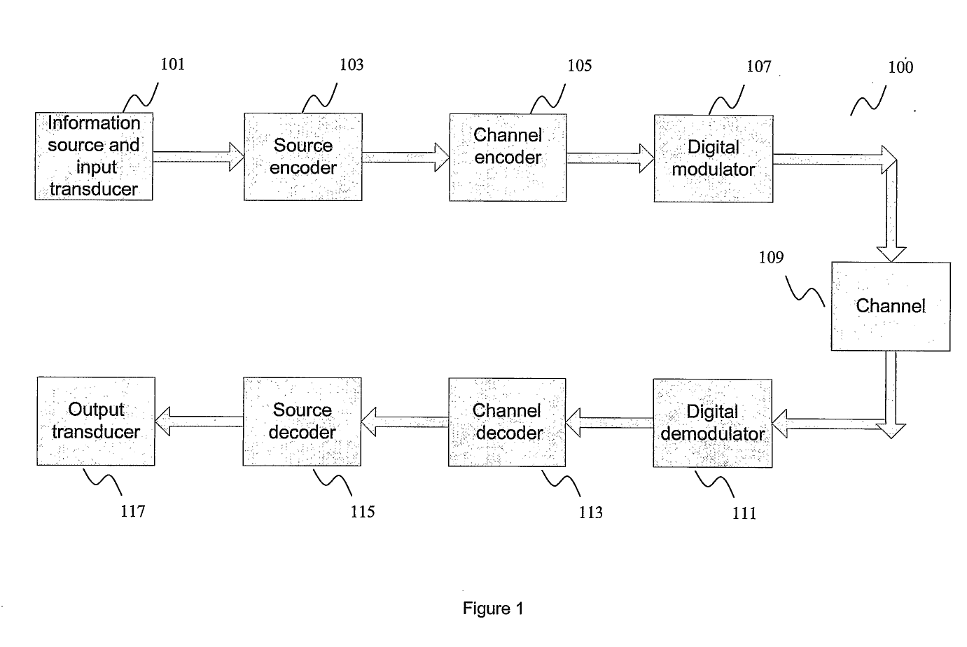

FIG. 1 shows a communication system according to one embodiment of the invention.

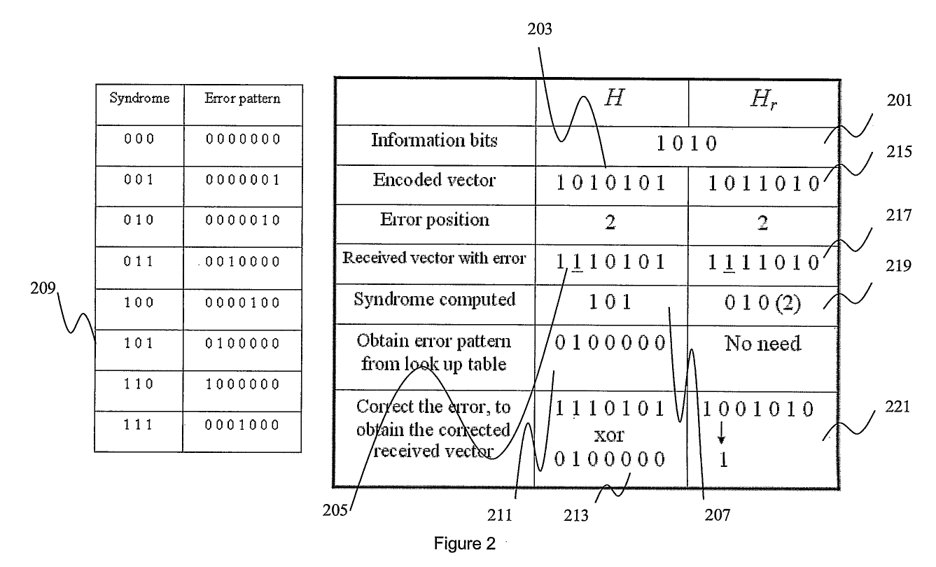

FIG. 2 shows the syndrome and the intermediate steps during by the encoding and decoding processes according to one embodiment of the invention.

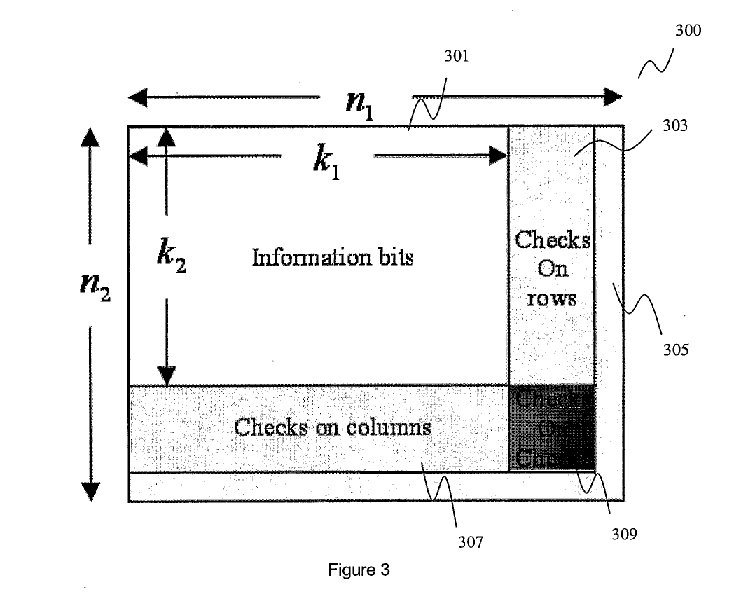

FIG. 3 shows an example of a turbo product code (TPC).

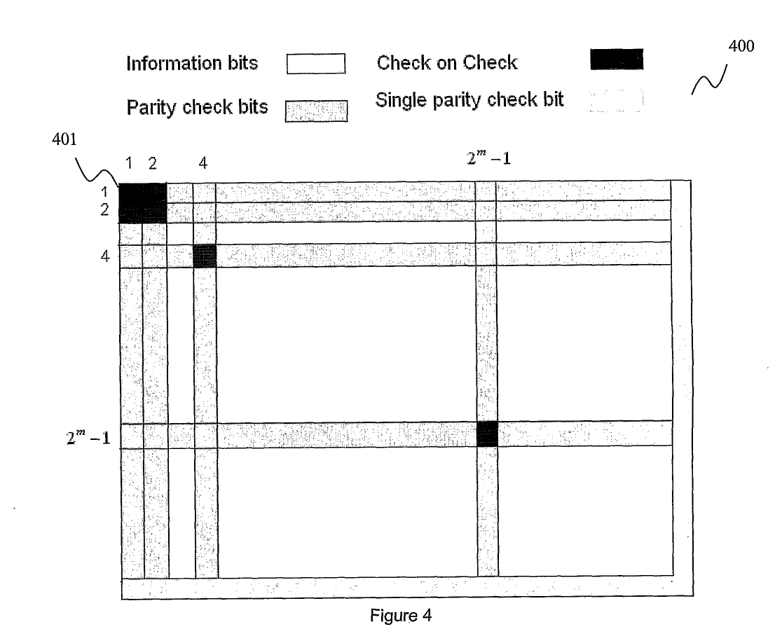

FIG. 4 shows an example of a turbo product code (TPC) according to an embodiment of the invention.

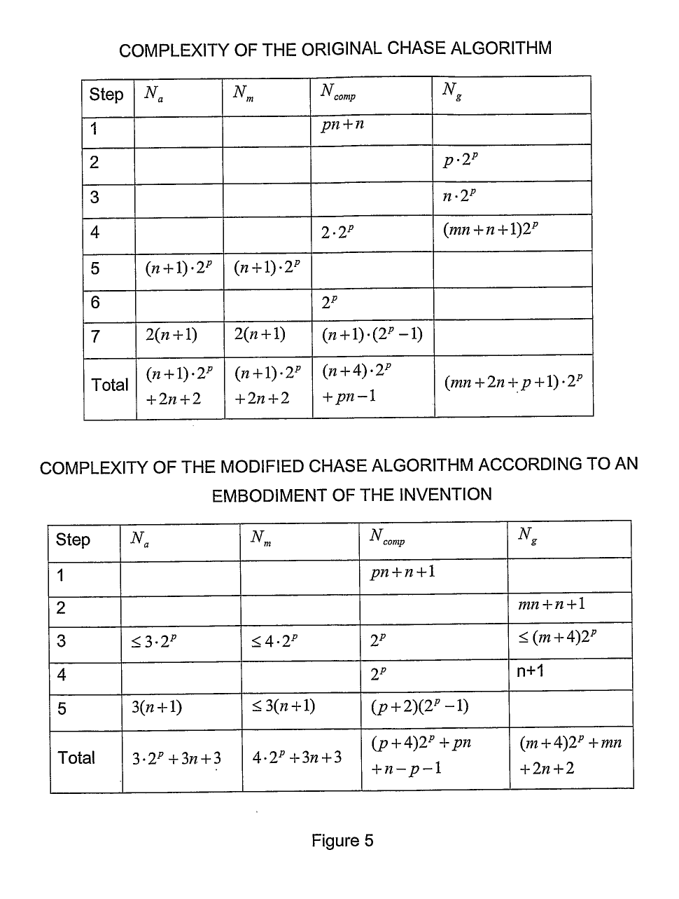

FIG. 5 shows a comparison of the decoding complexity of square turbo product code (TPC) encoded data block with n+1 columns and n+1 rows between the original Chase algorithm and the modified Chase algorithm according to an embodiment of the invention.

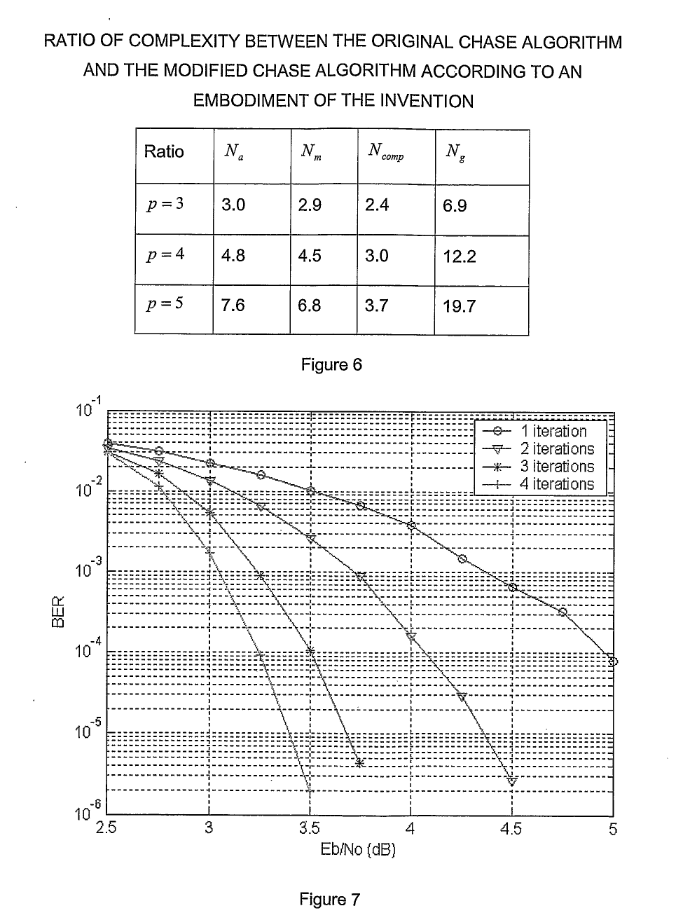

FIG. 6 shows a comparison of the decoding complexity of a (64, 57, 3) Hamming code block between the original Chase algorithm and the modified Chase algorithm according to an embodiment of the invention.

FIG. 7 shows the performance results of the decoder according to an embodiment of the invention.

FIG. 1 shows a communication system 100 according to one embodiment of the invention.

On the transmit path, the communication system 100 comprises an information source and input transducer 101, a source encoder 103, a channel encoder 105 and a digital modulator 107. A signal generated by information source and input transducer 101 will be processed by the source encoder 103, the channel encoder 105 and the digital modulator 107 before it is transmitted. The transmitted signal passes through a channel 109 before arriving at the receiver end, as the received signal.

On the receive path, the communication system 100 comprises a digital demodulator 111, a channel decoder 113, a source decoder 115 and an output transducer 117. The received signal is then processed through the components on the receive path, in order to retrieve a signal which is identical to the signal generated information source and input transducer 101, in an ideal scenario.

Each component on the transmit path has a corresponding component on the receive path. For example, there is a channel decoder 105 on the transmit path, and its corresponding component on the receive path is the channel decoder 113.

In a typical signal transmission in the communication system 100, it is possible that errors may occur in the signal. Errors usually occur during the transmission of the signal over the channel 109. Accordingly, a channel encoder 105 and its corresponding channel decoder 113 are provided in a typical communication system 100, to reduce and if possible, to eliminate errors which occur during signal transmission over the channel 109.

In this case, the channel encoder 105 may be a turbo product code (TPC) encoder, which may be implemented by the method of encoding data provided by this invention. Correspondingly, the channel decoder 113 may be a turbo product code (TPC) decoder, which may be implemented using the method of decoding data provided by this invention.

The turbo product code (TPC) encoder may be described as follows.

In the subsequent description, the following convention is used. X refers to a matrix or a vector set, and xⁱ refers to the i^{th} row of the matrix X. In this regard, xⱼⁱ refers to the i^{th} element of xⁱ. However, if X only has one row, then xⱼ refers to the j^{th} element of X.

C denotes a Hamming code encoded data vector (n, k, δ) with a generator matrix G and a parity check matrix H, where the code length, n=2^{m}−1, the number of information bits, k=n−m, and the minimum Hamming distance, δ=3, where m is a integer value. In addition, the code length, n, and the number of information bits, k, are also integer values. m is a settable value, with a condition that m≧3.

G may be represented in a systematic form as G=(Iₖ|P) with the k×(n−k) parity sub-matrix P. Accordingly, the corresponding parity check matrix H may be represented by H=(P^{T}|Iₖ) An example of each of the matrices G, H and P with m=3 is shown in Equations (1), (2), and (3), respectively. It can be seen that when m=3, n=7 and k=4.

$$\begin{matrix}G = ( \begin{matrix}1 & 0 & 0 & 0 & 1 & 1 & 0 \\ 0 & 1 & 0 & 0 & 1 & 0 & 1 \\ 0 & 0 & 1 & 0 & 0 & 1 & 1 \\ 0 & 0 & 0 & 1 & 1 & 1 & 1\end{matrix} ) & ( 1 ) \\ P = ( \begin{matrix}1 & 1 & 0 \\ 1 & 0 & 1 \\ 0 & 1 & 1 \\ 1 & 1 & 1\end{matrix} ) & ( 2 ) \\ H = ( \begin{matrix}1 & 1 & 0 & 1 & 1 & 0 & 0 \\ 1 & 0 & 1 & 1 & 0 & 1 & 0 \\ 0 & 1 & 1 & 1 & 0 & 0 & 1\end{matrix} ) & ( 3 )\end{matrix}$$

The encoding process for Hamming codes is typically denoted as c(c₁, . . . , cₙ)=(c₁, . . . , cₖ)G, using the generator matrix G. The information bits may also be encoded using the parity check matrix H. In the cases when k>(n−k), the encoding process using the parity check matrix H requires a lesser number of computations. In these cases, the encoding process using the parity check matrix H is implemented based on cH^{T}=0, such that the n−k parity check bits cₖ₊₁, . . . , cₙ are obtained as follows:

cⱼ=c₁p_{1,j}+c₂p_{2,j}+ . . . +cₖp_{k,j} k<j≦n (4)

Hamming codes have a special property such that their parity check matrix H has different values for all its columns. For example, in Equation (3), the parity check matrix H has values of (3, 5, 6, 7, 1, 2, 4) for all its columns, where the bits on the top row is the least significant bit (LSB) values.

If a single error occurs, for example, in position j, then the syndrome s of the received vector r denotes the column of H in the position in which the error occurred. Let e denote the error vector. Assuming that all of its components are equal to zero except for the j^{th} component, i.e., eⱼ=1, then the syndrome of the received vector s is given by

s=rH^{T}=eH^{T}=h^{j} (5)

where h^{j}=1 denotes the j-th column of H. For example, the list of possible syndromes for a single bit error in the Hamming code encoded data vector generated using the parity check matrix H given in Equation (3) is shown on the left section of FIG. 2.

From Equation (5), if the columns of H are expressed as the binary representation of the error location, then the value of the syndrome s may be directly used to determine the bit position of the error. In order to achieve this, the columns of the parity check matrix H may be rearranged such that the values of the columns are in an ascending order.

For example, in Equation (3), as shown earlier, the parity check matrix H has values of (3, 5, 6, 7, 1, 2, 4) for all its columns, where the bit at the top row is the least significant bit (LSB). By rearranging the values for all its columns as (1, 2, 3, 4, 5, 6, 7), the-following resulting matrix, Hr, is obtained:

$${H}_{r} = ( \begin{matrix}1 & 0 & 1 & 0 & 1 & 0 & 1 \\ 0 & 1 & 1 & 0 & 0 & 1 & 1 \\ 0 & 0 & 0 & 1 & 1 & 1 & 1\end{matrix} ) \qquad ( 6 )$$

Alternatively, the generation of the matrix Hr from the parity check matrix H may be expressed as

$$H = ( \begin{matrix}1 & 1 & 0 & 1 & 1 & 0 & 0 \\ 1 & 0 & 1 & 1 & 0 & 1 & 0 \\ 0 & 1 & 1 & 1 & 0 & 0 & 1\end{matrix} ) \to {H}_{r} = ( \begin{matrix}1 & 0 & 1 & 0 & 1 & 0 & 1 \\ 0 & 1 & 1 & 0 & 0 & 1 & 1 \\ 0 & 0 & 0 & 1 & 1 & 1 & 1\end{matrix} ) \qquad ( 7 )$$

The Hamming code encoded data vector generated using the matrix Hr is a rearranged version of the original Hamming code encoded data vector with parity check matrix H. In general, for a (n, k) Hamming code with n=2^{m}−1 and k=2^{m}−1−m, the parity check bits are located in the columns numbered 1, 2, 4 . . . 2^{m}−1 of Hᵣ. The rest of the encoded bits are arranged starting at column number 3, with the same ordering as when the parity check matrix H is used. This will be further described subsequently, with the illustration of FIG. 2.

At the decoder side, for the Hamming code encoded data vector generated using the parity check matrix H, the syndrome s is first computed using Equation (5) from the received vector. The syndrome computed is then used to obtain the corresponding error pattern from a look up table. The corrected received vector is then obtained by an exclusive-OR (XOR) operation on the received vector and the error pattern. Subsequently, the information bits can be recovered from the corrected received vector after removing the parity check bits.

However, for the Hamming code encoded data vector generated using the matrix Hr, a hard decision decoding is easy to implement since the syndrome s, computed by Equation (5), directly gives the bit position of the error. The bit in error is then inverted in the received vector, in order to obtain the corrected received vector. Therefore, there is no need for the step of referring to a look up table to obtain a corresponding error pattern to the syndrome computed. Accordingly, this property of Hamming codes generated using the matrix Hr may be used to reduce the complexity of the turbo product code (TPC) decoding process, which will be described subsequently.

As a further example, the encoding and decoding processes for encoded data vectors generated using the parity check matrix H and the matrix Hr are illustrated, as shown in FIG. 2. In this illustration, the information bits are taken as(c₁, . . . , cₖ)=(1, 0, 1, 0) 201.

For the parity check matrix H, using Equation (4) to obtain the parity check bits, the Hamming code encoded data vector generated is given by (c₁, . . . , cₙ)=(1, 0, 1, 0, 1, 0, 1) 203. During transmission, say, an error occurs in bit position 2. Therefore, the received vector r is given by (r₁, . . . , rₙ)=(1, 1, 1, 0, 1, 0, 1) 205.

The syndrome s of received vector is computed as follows

s=rH^{T}=(1, 1, 1, 0, 1, 0, 1)H^{T}=(1, 0, 1)^{T} (8)

Using the syndrome s obtained, (1, 0, 1) 207, from the look up table, the row 209 corresponding to the syndrome value of (1, 0, 1) 207 indicates that the corresponding error pattern is (0, 1, 0, 0, 0, 0, 0) 211. The corrected received vector, obtained by an exclusive-OR (XOR) operation on the received vector and the error pattern, is (1, 0, 1, 0, 1, 0, 1), which is the same as the encoded data vector 203.

For the parity check matrix Hᵣ, from Equation (6), it can be seen that the parity check bit positions are located in columns numbered 1, 2, 4 of Hᵣ. Thus, the transpose of the parity check sub-matrix P^{T}, may be obtained by deleting the columns numbered 1, 2 and 4.

From this matrix and Equation (4), the 3 parity check bits are obtained as (1, 0, 1) . Accordingly, the encoded vector or the Hamming code obtained is (1, 0, 1, 1, 0, 1, 0) 215, after inserting the parity check bits to column numbers 1, 2 and 4, and then inserting the information bits (1, 0, 1, 0) 201 into the remaining columns, starting from column 3.

Assuming that an error had occurred in bit position 2, the received vector r is therefore (1, 1, 1, 1, 0, 1, 0) 217. The syndrome s obtained for this received vector is

s=rH^{T}=(1, 1, 1, 1, 0, 1, 0)Hᵣ^{T}=(0, 1, 0)^{T}(=2) (9)

As this syndrome (0, 1, 0) 219 directly gives the bit position of the error bit, the corrected received word obtained is (1, 0, 1, 1, 0, 1, 0) 221 by inverting the bit at bit position 2. It can be seen that the corrected received word is the same as the encoded data vector. Accordingly, it can be seen from this illustration that the decoding process for the Hamming code encoded data vector generated using the matrix Hᵣ is simplified, since the syndrome computed directly gives the bit position of the error bit.

As described earlier, the matrix Hᵣ is generated from a parity check matrix H by rearranging the columns of the parity check matrix H such that the values of the columns are in an ascending order. An alternative matrix Hᵣ^{E} may also be generated in a similar manner as the matrix Hᵣ, and the Hamming codes generated using the matrix Hᵣ^{E} also possess the same unique properties as the Hamming codes generated using the matrix Hᵣ. In order to differentiate from the Hamming codes generated using the matrix Hᵣ, the Hamming codes generated using the matrix Hᵣ^{E} are henceforth referred to as extended Hamming codes.

The matrix Hᵣ^{E} may be generated as follows. Firstly, a column of all zeroes is appended to the rightmost column of the parity check matrix H. Secondly, a column of all zeroes is appended to the rightmost column of the parity check matrix H. The intermediate resultant matrix H^{E} is shown as follows:

$$H = ( \begin{matrix}1 & 1 & 0 & 1 & 1 & 0 & 0 \\ 1 & 0 & 1 & 1 & 0 & 1 & 0 \\ 0 & 1 & 1 & 1 & 0 & 0 & 1\end{matrix} ) \to {H}^{E} = ( \begin{matrix}1 & 1 & 0 & 1 & 1 & 0 & 0 & 0 \\ 1 & 0 & 1 & 1 & 0 & 1 & 0 & 0 \\ 0 & 1 & 1 & 1 & 0 & 0 & 1 & 0 \\ 1 & 1 & 1 & 1 & 1 & 1 & 1 & 1\end{matrix} ) \qquad ( 10 )$$

Following this, the matrix Hᵣ^{E} is generated from a parity check matrix H^{E} by rearranging the columns of the parity check matrix H^{E} so that values of the columns are in an ascending order, as shown

$${H}^{E} = ( \begin{matrix}1 & 1 & 0 & 1 & 1 & 0 & 0 & 0 \\ 1 & 0 & 1 & 1 & 0 & 1 & 0 & 0 \\ 0 & 1 & 1 & 1 & 0 & 0 & 1 & 0 \\ 1 & 1 & 1 & 1 & 1 & 1 & 1 & 1\end{matrix} ) \to {H}_{r}^{E} = ( \begin{matrix}0 & 1 & 0 & 0 & 0 & 1 & 0 & 1 \\ 0 & 0 & 1 & 1 & 0 & 0 & 1 & 1 \\ 0 & 0 & 0 & 1 & 1 & 1 & 1 & 1 \\ 1 & 1 & 1 & 1 & 1 & 1 & 1 & 1\end{matrix} ) \qquad ( 11 )$$

Next, the procedure of generating a turbo product code (TPC) according to an embodiment of the invention is described. For example, a turbo product code (TPC) may be generated based on two Hamming codes C¹(n₁, k₁, δ₁) and C²(n₂, k₂, δ₂), which are generated by using the matrix Hᵣ described earlier, as follows:

1) arranging (k₂ k₁) information bits in an array of k₂ rows and k₁ columns,
2) encoding the k₂ rows using code C¹,
3) encoding the k₁ columns using code C², and
4) calculating and then inserting the parity check bits accordingly for the corresponding rows and columns.

The codeword length, the number of information bits and the minimum Hamming distance of the turbo product code (TPC) generated according to the procedure described earlier are n₁×n₂, k₁×k₂ and δ₁×δ₂ respectively. This means a long block code with a large minimum Hamming distance, may be obtained from two short block codes with small minimum Hamming distances.

FIG. 3 shows a turbo product code (TPC) encoded data block 300 generated using the parity check matrix H, while FIG. 4 shows a turbo product code (TPC) encoded data block 400 generated using the parity check matrix Hᵣ according to an embodiment of the invention.

In FIG. 3, the bits (1, . . . , k₁) on a row i where i≦k₂, are the information bits 301. On that same row i, the bits (kᵢ+1, . . . , nᵢ−1) are the parity check bits for row i 303, and bit nᵢ may be a single parity check bit for the whole row i 305.

Similarly, the bits (1, . . . , k₂) on a column j where j≦k₁, are the information bits 301. On that same column j, the bits (k₂+1, . . . , n₂−1) are the parity check bits on column j 307, and bit n₂ may be a single parity check bit for the column j 305.

Finally, the bits (kᵢ+1, . . . , nᵢ−1) on a row i where k₂≦i≦n₂−1, are the parity check bits on parity check bits 309. This is because the bits (1, . . . , kᵢ) on a row i where k₂≦i≦n₂−1, are all parity check bits (on columns) 307. Accordingly, when an encoding process is carried out on a row of parity check bits, the parity check bits obtained as a result of the encoding process are parity check bits on parity check bits.

On the other hand, in FIG. 4, it can be seen that the parity check bits are located in the rows as well as the columns numbered 1, 2, 4 . . . 2^{m}−1. In addition, the bits where the row and the column are both numbered as one of 1, 2, 4 . . . 2^{m}−1, are the parity check bits on parity check bits 401. Accordingly, the special properties of the matrix Hᵣ and of the encoded vector generated using the matrix Hᵣ described earlier are also in the turbo product code (TPC) encoded data block shown in FIG. 4.

From the illustration of FIG. 2, it can be seen that the decoding of the Hamming code encoded data vector generated using the matrix Hᵣ does not require a look-up table to obtain the error pattern corresponding to the syndrome computed from the received vector, thereby reducing the decoding complexity. Accordingly, the decoding complexity for the TPC encoded data block shown in FIG. 4 will be reduced even further compared to the TPC encoded data block shown in FIG. 3. This is because the decoding process for the TPC encoded data block shown in FIG. 3 involves multiples of the product of the row index and the column index for every iteration in the decoding process.

Next, a description is given on how the encoding rate of the turbo product code (TPC) may be modified. Typically every encoder has an encoding rate, which is usually given as a ratio between the number of information bits (on its input) and the number of encoded data bits (on its output). If an encoder does not have a desired encoding rate, a process called (encoding) rate matching may be implemented after the encoding process, in order to obtain the desired encoding rate.

For the turbo product code (TPC) described earlier, the rate matching may be carried out with a combination of the following steps:
a) deleting a predetermined number of rows from the encoded data block,
b) deleting a predetermined number of columns from the encoded data block,
c) deleting a predetermined number of bits from a row in the encoded data block,
d) replacing a predetermined number of bits from a row in the encoded data block with a predetermined set of values.

Typically, for step (d), the predetermined set of values used for replacing a predetermined number of bits from a row in the encoded data block is a set of all zero values. The predetermined set of values used for replacing a predetermined number of bits from a row in the encoded data block may also be cyclic redundancy check (CRC) bits generated from the information bits.

The use of the cyclic redundancy check (CRC) here allows a quick check to be performed in order to determine whether there are errors in the information bits at the receiver side. If it is determined that there were no errors in the information bits, the information bits may be simply extracted from the encoded data block without having to go through the turbo product code (TPC) decoding process.

Next, the turbo product code (TPC) decoder can be described as follows.

As mentioned earlier, in order to further reduce the complexity of decoding turbo product codes, the Chase algorithm [4] has been used to obtain extrinsic information on each bit position for iterative decoding. However, it was observed that the Chase algorithm is still relatively high in terms of complexity.

It was observed that a number of steps in the Chase algorithm are typically implemented with a loop structure. Accordingly, a reduction of complexity may be achieved by optimizing the steps within the loop structure. According to one embodiment of the invention, the reduction of decoding complexity is considered from both the decoding aspect as well as the encoding aspect. The reduction of decoding complexity considered from the encoding aspect has been described earlier, and now, the reduction of decoding complexity will be considered from the decoding aspect.

The reduction of decoding complexity considered from the decoding aspect may be described as follows. Using the procedure of generating the turbo product codes (TPC) described earlier, the modified Chase algorithm according to an embodiment of the invention may be implemented according to the following steps:

1) From a received signal, for example, a binary phase shift keying (BPSK) modulated signal {1→1 ,0→−1} with phase correction, denoted as r=(r₁, r₂, . . . , rₙ₊₁),
a) generate a reliability sequence r^{abs}=(|r₁|, |r₂|, . . . , |rₙ₊₁|),
b) generate a binary sequence y=(y₁, r₂, . . . , yₙ, yₙ₊₁), where yᵢ is equal to 1 if rₗ>0 and to 0 if rₗ≦0, and
c) determine the p least reliable bit position of sequence (ythd 1, r₂, . . . , yₙ) using r^{abs}.
   2) a) initialize the test pattern, the analog weight, the syndrome, and the extended bit, which are defined as follows:

t¹=(0, . . . , 0, . . . , 0)_{1×(n+1)},

wtt=0

s=(y₁, y₂, . . . yₙ)Hᵣ^{T},

$$eb = mod ( {\sum }_{l = 1}^{n + 1} {y}_{l} , 2 ) ,$$

where pᵢ∈[1, n] index of non-zero bit in tⁱ=tⁱ⁺¹
b) reorder the test patterns such that a test pattern differs from its adjacent test patterns by only 1 bit.
   3) Perform within a 2^{p} loop,
a) determine the extended bit, perturb the test patterns (if an error occurs), and calculate the analog weight, as follows:

j^{j}(n+1)=eb,

wⱼ=wtt,
if s≠0 then
t^{j}(sᵥ)=t^{j}(sᵥ)⊕1,
t^{j}(n+1)=t^{j}(n+1)⊕1, and
wⱼ=wⱼ+tⱼ(sᵥ)*|r(sᵥ)|,
where t^{j}(n+1) is the (n+1)^{th} element of tⁱ and sᵥ is the integer value of the syndrome s, and

wⱼ=wⱼ+t^{j}(n+1)*|r(n+1)|.
b) generate the next test sequence, compute the syndrome, calculate the extended bit and compute the analog weight, as follows:
tⁱ⁺¹=tⁱ (with bit pᵢ inverted),
s=s⊕pᵢ,
eb=eb⊕1, and
wtt=wtt+(2*tⁱ⁺¹(p₁)−1)|r(pᵢ)|.
   4) Estimate the maximum likelihood codeword d from valid codeword set

$$d = y ⊕ {t}^{j} where ( j ) = arg {min}_{j ∈ [ 1 , {2}^{P} ]} {w}_{j}$$

5) Compute the extrinsic information for the received signal
a) for P least reliable bit positions and error corrected positions

gᵢ=(2dᵢ−1)(w_{c}−w_{d})−rᵢ (12)
where w_{d} and w_{c} are the analog weights of the maximum likelihood decoded sequence d and the competing decoded sequence C^{ex} respectively.
b) for all other positions

gᵢ=(2dᵢ−1)(wₘₐₓ−w_{d})/p (13)
where wₘₐₓ, the maximum analog weight.

With regard to Step 5(a), similar to the original Chase algorithm, if a bit of the maximum likelihood decoded sequence d has more than one competing decoded sequence, w_{c} is the lowest value in the analog weight among the competing decoded sequences. Here, the competing decoded sequence is searched from all test sequences instead of just a candidate decoded sequence set as done in the original Chase algorithm. By doing so, a complexity reduction in the decoded sequence search process is achieved.

For the p least reliable bit positions and the error corrected position of test sequence with the smallest analog weight, the decoding computation complexity is same as the original Chase algorithm, which requires 2^{p} comparator operations for each bit position. However, for the rest of the error corrected positions, the computing complexity is greatly reduced because the weights of competing decoded sequences are the same as the weights of the test sequences where error corrected operations occur in a corresponding position, and hence, no additional computation is required.

With regard to Step 5(b), the parameter β used in the original Chase algorithm requires a normalization of the extrinsic information, which in turn requires a large amount of computation. As Equation (13) does not have the parameters β, as used in the original Chase algorithm, there is no need to perform a normalization of the extrinsic information. Accordingly, the decoding complexity is reduced significantly.

FIG. 5 shows a comparison of the decoding complexity of a square turbo product code (TPC) encoded data block with n+1 columns and n+1 rows between the original Chase algorithm and the modified Chase algorithm according to an embodiment of the invention. The comparison only considers the computational complexity of one component codeword (one column or one row of a square turbo product code (TPC) encoded data block.

According to the encoding process of the square turbo product code (TPC) encoded data block, the block component code in horizontal and vertical directions are equivalent. Accordingly, the decoding complexity of one iteration in both directions (along the row direction and along the column direction) may simply be the decoding complexity of one component vector multiplied by 2(n+1).

A comparison on the number of operations for the original Chase algorithm, and for the modified Chase algorithm according to one embodiment of the invention, is shown in the tables of FIG. 5, respectively. The following notations are used in the tables shown in FIG. 5:

a) the number of real number additions is denoted by Nₐ
b) the number of real number multiplications is denoted by Nₘ
c) the number of comparator operations is denoted by N_{comp}
d) the number of GF(2) additions is denoted by N_{g}

To facilitate the comparison of the complexity of the original Chase algorithm and the modified Chase algorithm according to one embodiment of the invention, numerical values of the number of different operations required by both algorithms for the turbo product code (TPC) generated using the Hamming code (64, 57, 3) is provided in the form of a ratio in FIG. 6. For example, for the number of GF(2) additions, N_{g}, with p=5, the modified Chase algorithm according to an embodiment of the invention uses 19.7 times less GF(2) additions compared to the original Chase algorithm.

Since every numerical value of the ratios shown in FIG. 6 is greater than 1, this means that the modified Chase algorithm according to an embodiment of the invention uses less operations compared to the original Chase algorithm, for all types of operations, including real number additions, real number multiplications, comparator operations or GF(2) additions. Therefore, the decoding complexity is significantly reduced using the modified Chase algorithm according to an embodiment of the invention.

FIG. 7 shows the performance results of the decoder according to an embodiment of the invention. The results shown in FIG. 7, when compared to published performance results of the original Chase algorithm, indicate that there is negligible performance difference between the original Chase algorithm and the modified Chase algorithm according to one embodiment of the invention. This means that the reduction in decoding complexity using the modified Chase algorithm according to one embodiment of the invention is gained without any loss in performance.

In this document, the following publications are cited:

Berrou, C., et al., “Near optimum error correcting coding and decoding: Turbo codes”, IEEE Trans. Commun., vol. 44, no. 10, pp. 1261-1271, October 1996.

Pyndiah, R., “Near-optimum decoding of product codes: block turbo codes”, IEEE Trans. Commun., vol. 46, no.8, pp. 1003-1010, August 1998.

Pyndiah, R., et al., “Near-optimum decoding of product codes”, Proc. IEEE GLOBECOM'94, vol. 1/3, pp. 339-343, November 1994.

Chase, D., “A class of algorithms for decoding block codes with channel measurement information”, IEEE Trans. Inform. Theory, vol. IT-18, pp. 170-182, January 1972.

What is claimed is:

1. A method for decoding an input data sequence, comprising
generating a plurality of test sequences;
determining an order for the plurality of test sequences, such that each test sequence differs from its adjacent test sequences by a respective predefined number of bits; and
carrying out a maximum likelihood process with the ordered test sequences and the input data sequence thereby generating a maximum likelihood sequence.

2. The method of claim 1, further comprising determining a reliability indicator for the maximum likelihood sequence generated.

3. The method of claim 2, wherein the coefficient for the reliability indicator for maximum likelihood sequence generated comprising the difference between the maximum weight and the weight of the maximum likelihood sequence generated.

4. The method of claim 3, wherein the coefficient for the reliability indicator for maximum likelihood sequence obtained further comprising the number of least reliable bit positions in the maximum likelihood sequence generated.

5. The method of claim 1, further comprising perturbing the test sequences when an error is encountered.

6. The method of claim 5, wherein perturbing the test sequences comprises inverting predetermined bits of the test sequences.

7. The method of claim 1, wherein the respective predefined number of bits is 1 bit.

8. A decoding device, comprising
a generator generating a plurality of test sequences;
a first unit for determining an order for the plurality of test sequences, such that each test sequence differs from its adjacent test sequences by a respective predefined number of bits; and
a second unit for carrying out a maximum likelihood process with the ordered test sequences and the input data sequence thereby generating a maximum likelihood sequence.

9. The device of claim 8, further comprising a third unit for determining a reliability indicator for the maximum likelihood sequence generated.

10. A computer program product which, when executed by a computer, makes the computer perform a method for decoding an input data sequence, comprising
generating a plurality of test sequences;
determining an order for the plurality of test sequences, such that each test sequence differs from its adjacent test sequences by a respective predefined number of bits; and
carrying out a maximum likelihood process with the ordered test sequences and the input data sequence thereby generating a maximum likelihood sequence.

11. The computer program product of claim 10, when executed by a computer, makes the computer perform a method for decoding an input data sequence, further comprising determining a reliability indicator for the maximum likelihood sequence generated.

12. A method of encoding an input data sequence, comprising
determining at least one encoding matrix;
ordering the at least one encoding matrix determined;
arranging the input data sequence into an input data matrix; and
performing operations on the input data matrix using the at least one encoding matrix arranged thereby generating an encoded data block.

13. The method of claim 12, wherein ordering the at least one encoding matrix determined comprising arranging the columns of the at least one encoding matrix such that the integer values represented by the bit values in each column are in an ascending order, wherein the bit at the top row corresponds to the least significant bit of each column.

14. The method of claim 12, further comprising
appending a column of predetermined values after the rightmost column of the at least one encoding matrix determined; and
appending a row of predetermined values below the bottom row of the at least encoding matrix determined,
before ordering the at least one encoding matrix determined.

15. The method of claim 12, wherein the column of predetermined values being a column of all zeroes.

16. The method of claim 12, wherein the row of predetermined values being a row of all ones.

17. The method of claim 12, further comprising
removing predetermined rows of the encoded data block.

18. The method of claim 17, further comprising
removing predetermined columns of the encoded data block.

19. The method of claim 18, further comprising
removing a predetermined set of continuous bits of the encoded data block.

20. The method of claim 18, further comprising
replacing a predetermined set of continuous bits of the encoded data block with predetermined data.

21. The method of claim 20, wherein the predetermined data is a set of all zero values.

22. The method of claim 20, wherein the predetermined data is cyclic redundancy check (CRC) data.

23. An encoding device, comprising
a first unit for determining at least one encoding matrix;
a second unit for ordering the at least one encoding matrix determined;
a third unit for arranging the input data sequence into an input data matrix; and
a fourth unit for performing operations on the input data matrix using the at least one encoding matrix arranged thereby generating an encoded data block.

24. A computer program product which, when executed by a computer, makes the computer perform a method for encoding an input data sequence, comprising
determining at least one encoding matrix;
ordering the at least one encoding matrix determined;
arranging the input data sequence into an input data matrix; and
performing operations on the input data matrix using the at least one encoding matrix arranged thereby generating an encoded data block.
